(19) United States
(12) Patent Application Publication
(10) Pub. No.: US 2010/0308999 A1
(43) Pub. Date: Dec. 9, 2010

(54) SECURITY AND MONITORING APPARATUS

(76) Inventor: TODD E. CHORNENKY, BETHEL PARK, PA (US)

Correspondence Address: James Ray & Associates, 2640 Pitcairn Road, Monroeville, PA, 15146, US

(21) Appl. No.: 12/479,229

(22) Filed: Jun. 5, 2009

(51) Int. Cl. G08B 23/00; G06F 19/00

(52) U.S. Cl. 340/573.1; 700/245

(57) ABSTRACT

An apparatus for enabling a user to control a machine, perform a procedure, interface with a predetermined object and monitor conditions. The apparatus includes a device which is fastened to at least one of the ear and the portion of skin adjacent the ear of the user. The device includes a sensing mechanism engageable with at least one of a human ear and a portion of skin adjacent the ear for at least one of identifying characteristics of a user and detecting removal of the sensing mechanism from the user. A control assembly is provided with a first portion mounted within the device and with the second portion mounted in a remote location. A transmitting mechanism is connected to the sensing mechanism for sending at least one signal to the predetermined object at least one of periodically, sporadically and continuously containing data gathered by the sensing mechanism.

### CROSS-REFERENCE TO RELATED APPLICATIONS

This application is related to U.S. Pub. No. 2005/0238194 published Oct. 27, 2005 entitled “Ear Associated Machine-Human Interface” and PCT/US2007/024354 entitled “Security and Monitoring Appratus”. This application is further related to U.S. Pub. No. 2005/0219842 published Oct. 6, 2005 and entitled “Illumination Matrix With Substantially Symmetrical Arrangement”. This application is additionally related to U.S. Pat. No. 6,943,665 issued Sep. 13, 2005.

### FIELD OF THE INVENTION

The present invention relates, in general, to security and monitoring devices, and, more particularly, the invention relates to a security device that is engageable with a human ear to authenticate a person using a sensor capable of sensing head movement and position before allowing such person to use a particular device or access to a specific area or to monitor health parameters and well being of the person.

### BACKGROUND OF THE INVENTION

Prior to the conception and development of the present invention, as is well known in the prior art, security and monitoring devices used for various purposes, such as locking and unlocking mechanisms, operating a machine, enabling and disabling events, allowing and disallowing access to specific areas, monitoring health related parameters and general well being of a person, etc. have been in existence throughout the world for many years. All of these security device functions require some type of validation method or device to distinguish a valid user from an invalid user. Most, if not all, of these devices require the use of hands to perform a related function. Some common devices include keys, rings, cards, gloves, etc. which have a specific code embedded in them, or emit a predetermined signal, to authorize a specific function such as unlocking a door or allowing a device to be used.

However, such devices cannot offer common (headset) functionality with the ability to easily, accurately and unobtrusively identify or authenticate the user/bearer or their state without requiring additional time, effort, manual action, and/or offering high security and/or offering capability to interact with the user and/or user's security environment.

In using a set or preset validation signal (whether electronic, magnetic, or other type), the prior art devices are not amenable to retrofitting and may be easily duplicated. If the signaling device is obtained or the signal is obtained from another source, an unauthorized user has access and/or control over the locked system.

Therefore, a need exists for a security and monitoring device that can be comfortably and unobtrusively be worn/carried and yet offer a wide range of fast, convenient, easy uses, user interaction capabilities, specific identification capabilities, user state specific action and intelligent decision making capabilities, and authentication context state specific intelligent decision making capabilities.

Therefore, a need exists for a security and monitoring device that can be retrofitted into existing mechanisms and 1O systems and produces a signal that cannot be easily duplicated or detected, thereby increasing the security aspect of the device.

U.S. Pub. No. 2005/0238194 published Oct. 27, 2005 and entitled “Ear Associated Machine-Human Interface” discloses one type of such security and monitoring device which can detect when the user's ear is pulled back to initiate a plurality of procedures. However, it has been found that, for many, such device require the use of the hand to pull the ear back.

Therefore, there is a need for security and monitoring device that provides a hands-free operation.

### SUMMARY OF THE INVENTION

According to one embodiment, the invention provides an apparatus that includes a head rotation sensor disposed in a predetermined position for detecting at least one of a head movement and a head position of a user and generating at least one information signal containing information about the head movement and the head position of such user. A control means having a first portion is coupled to the sensor for receiving the at least one information signal and a second remotely disposed portion for processing the at least one information signal in accordance with a predetermined logic. Means is coupled to the control means and is operable thereby to generate at least one control signal in response to receipt of the at least one information signal.

According to another embodiment of the invention, there is provided a communication headset. The communication headset includes an ear mount. A communication base unit is connected to the ear mount. A head rotation sensor is mounted within the base unit for detecting at least one of a head movement and a head position of a user and generating at least one information signal containing information about the head movement and the head position of such user. A control means having a first portion coupled to the sensor for receiving the at least one information signal and a second remotely disposed portion for processing the at least one information signal in accordance with a predetermined logic.

According to yet another embodiment, the invention provides a pair of glasses. The pair of glasses includes a frame having two lens holders connected by a nose bridge and two support arms each having a first end thereof affixed to a respective lens holder and having a second end thereof configured for engagement with an ear of a user. A head rotation sensor is secured to a first predetermined portion of the frame unit for detecting at least one of a head movement and a head position of a user and generating at least one information signal containing information about the head movement and the head position of such user. A control means having a first portion coupled to the sensor for receiving the at least one information signal and a second remotely disposed portion for processing the at least one information signal in accordance with a predetermined logic.

According to a further embodiment of the invention, there is provided an article of headwear. The article of headwear includes a head portion which is configured to receive a head of a wearer. A head rotation sensor is secured to a first predetermined portion of the head portion unit for detecting at least one of a head movement and a head position of a wearer and generating at least one information signal containing information about the head movement and the head position of such wearer. A control means having a first portion coupled to the sensor for receiving the at least one information signal and a second remotely disposed portion for processing the at least one information signal in accordance with a predetermined logic.

According to yet a further embodiment, the invention provides a method of transmitting commands. The method includes the steps of sensing at least one of a head movement and a head position of a user and turning on a device mounted on the user when the sensing occurs.

According to yet a further embodiment, the invention provides a method for controlling a robot or a robotic vehicle. The method includes the steps of pointing a head mounted laser in a predetermined direction and issuing at least one voice command associated with movement of the robot or robotic vehicle.

According to yet a further embodiment, the invention provides a method of controlling an object. The method includes the steps of providing a headset capable of executing communication protocol, measuring, at the receiver mounted on the object, strength of a radio frequency signal emitted by the headset, and executing a procedure based on the signal strength.

According to yet a further embodiment, the invention provides a security device for enabling a user to interface with a predetermined object. The security device includes a sensing means engageable with at least one of a human ear and a predetermined portion of skin adjacent the human ear for at least one of identifying pre-selected characteristics of a user and detecting removal of the sensing means from the user. A transmitting means is connected to the sensing means for sending at least one predetermined signal to the predetermined object at least one of periodically, sporadically and continuously. The predetermined signal can also contain additional data gathered by the sensing means. Finally, a fastening means attaches the sensing means and transmitting means to such at least one of the human ear and the predetermined portion of skin adjacent the human ear of the user.

### OBJECTS OF THE INVENTION

It is, therefore, one of the primary objects of the present invention to provide an apparatus engageable with a human ear or the area around the human ear that can identify/authenticate a user before allowing the user access to predetermined areas, or before the user can use pre-selected equipment.

Another object of the present invention is to provide an apparatus engageable with the human ear or the area around the human ear that can continuously monitor whether the device is removed from the user or still remains on the user.

Still another object of the present invention is to provide an apparatus engageable with the human ear or the area around the human ear that can be incorporated into existing devices and systems to increase the security of such devices and systems.

Still another object of the present invention is to provide an apparatus engageable with the human ear or the area around the human ear that can record/read/discern properties of that ear region.

Still another object of the present invention is to provide an apparatus engageable with the human ear or the area around the human ear that can allow user interaction and indication of user consciousness state, health state, knowledge or intent with it through signals available from that region, or if removed, from other regions of the body.

Still another object of the present invention is to provide an apparatus engageable with the human ear or the area around the human ear that can warn others of the user's present security status or presence within a range or under specified conditions.

Still another object of the present invention is to provide an apparatus engageable with the human ear or the area around the human ear that can record/replay security information upon proper request.

Still another object of the present invention is to provide an apparatus engageable with the human ear or the area around the human ear that can direct/enable the security system on the ear or external to the ear to be aware of the user's movements and actions relative to a fixed location, environmental conditions (such as fire), other users, security assets, or the location of other moving elements.

Still another object of the present invention is to provide an apparatus engageable with the human ear or the area around the human ear that can direct/require the user to act/not act in a specific manner based on the situation, context or environment the user is in.

Still another object of the present invention is to provide an apparatus engageable with the human ear or the area around the human ear that can record/read/discern the physical or security aspects of the environment the user is in.

Still another object of the present invention is to provide an apparatus engageable with the human ear or the area around the human ear that can enable the user to remotely operate a machine in a hands-free manner.

Still another object of the present invention is to provide an apparatus engageable with the human ear or the area around the human ear that can also simultaneously function as a simple useful human machine interface, decorative ear wear, earmuffs, ear protection, Bluetooth headset, medical monitor, or security badge.

Still another object of the present invention is to provide an apparatus engageable with the human ear or the area around the human ear that can be comfortably worn, moved, shared or removed by the user(s).

Yet another object of the present invention is to provide an apparatus engageable with the human ear or the area around the human ear that can be manufactured relatively inexpensively.

In addition to the above described objects and advantages of the present invention, various additional objects and advantages of the security device according to the instant invention will become more readily apparent to those persons skilled in the relevant art from the following more detailed description, particularly, when such description is taken in conjunction with the attached drawing figures and with the appended claims.

### BRIEF DESCRIPTION OF THE DRAWINGS

FIG. 1 is a perspective view of the device for sensing head position and movement of the user and for transmitting at least one control signal;

FIG. 2 is a side elevation view showing the device of FIG. 1 worn by the on the ear;

FIG. 3 is a block diagram of the apparatus of the present invention for controlling machine, monitoring a condition or a performing a function;

FIG. 4 is a perspective view of the device of FIG. 1 in combination with the pair of eye glasses;

FIG. 5 is a side elevation view of the device of FIG. 1 in combination with an article of headwear;

FIG. 6, is block diagram of the headset incorporating the device of FIG. 1 for controlling a vending machine;

FIG. 7 is a block diagram of a remotely disposed portion of the control means of the present invention;

FIG. 8 is a view of the device of FIG. 1 being secured to the ear by piercing;

FIG. 9 is a view of the device of FIG. 1, particularly showing a flexible, deformable piezoelectric strip used in conjunction with a fingerprint reader;

FIG. 10 is a view of the device of FIG. 1, particularly showing an array of capacitance proximity sensor plates behind the ear;

FIG. 11 is a view of the device of FIG. 1, particularly showing a magnetic sensor worn on one side of the ear and a removable magnet attached to an opposite side of the ear; and

FIG. 12 is a view of a mechanical assembly for clamping the device of FIG. 1 onto the ear of the user.

### DETAILED DESCRIPTION OF A PRESENTLY PREFERRED AND VARIOUS ALTERNATIVE EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

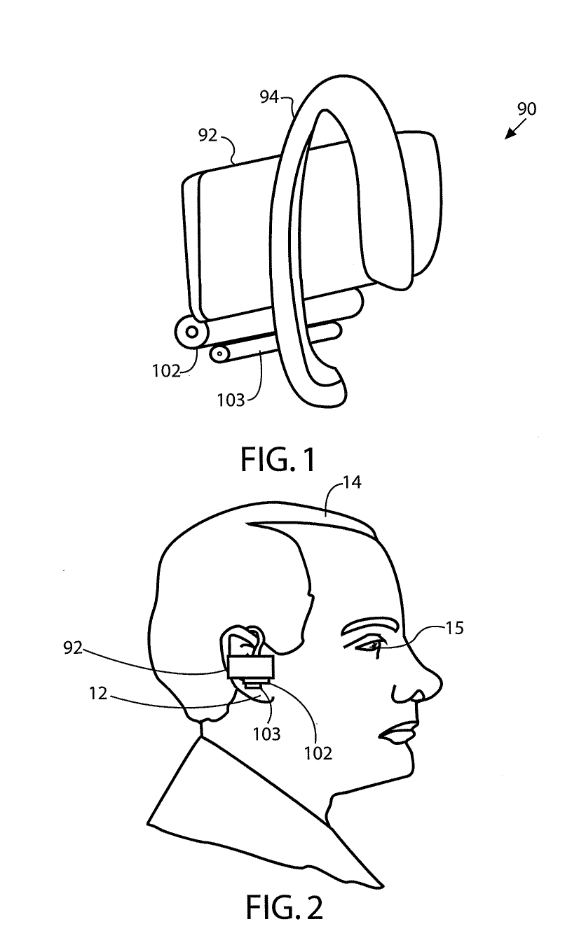

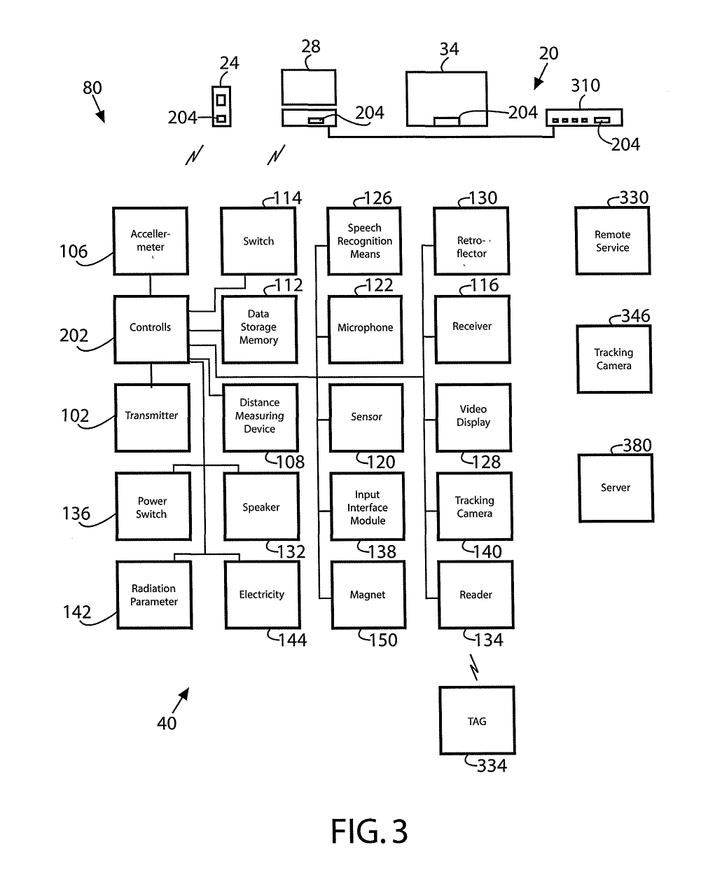

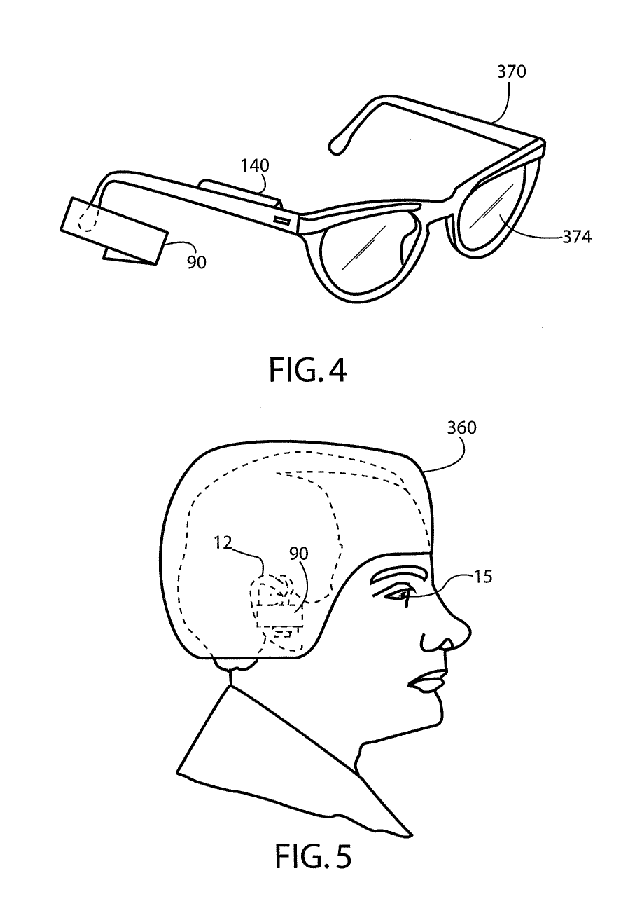

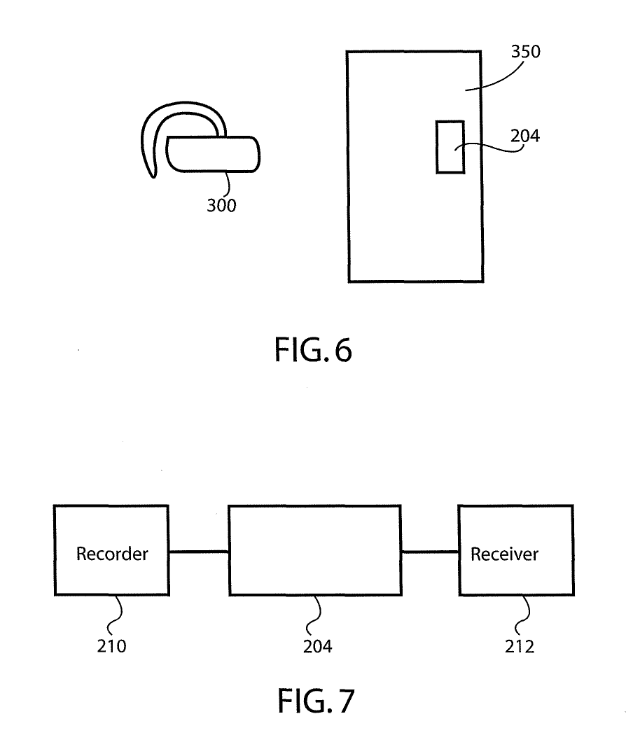

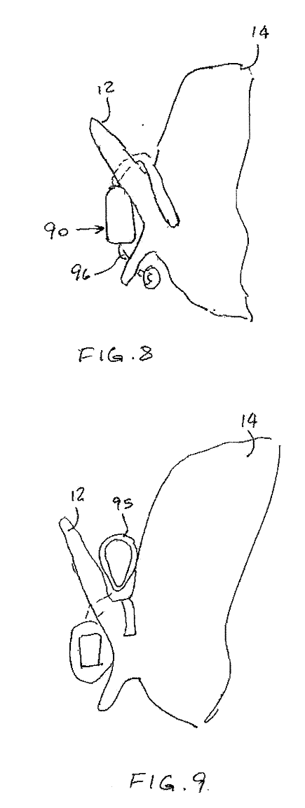

Now in reference to FIGS. 1-12, the present invention provides an apparatus, generally designated as 80, which may be used in a verity of applications. The apparatus 80 includes a device, generally designated as 90, engageable, either directly or indirectly, with a predetermined portion of a human body. In accordance with a presently preferred embodiment of the invention, such predetermined body portion is at least one of a human ear 12 and a predetermined portion of skin adjacent such human ear.

The device 90 includes a housing 92. There is also provided means for attaching the housing 92 to the ear 12 of the user. Such attachment means may be a simple curved hook 94 which is positioned between the ear 12 and the skin adjacent the year.

The device 90 is generally constructed according to principles disclosed in U.S. Pub. No. 2005/0238194 published Oct. 27, 2005 and entitled “Ear Associated Machine-Human Interface” and whose teachings are incorporated herein by reference thereto.

The present invention also takes advantage of sensing, by a sensing means 106 engageable, either directly or indirectly, with a predetermined portion of a human skin, movement and position of the user's head 14 either in a stand alone manner or in combination with other command generating means in order to generate at least one information signal containing information about the head movement and the head position based on the predetermined head movement and position logic. The sensing means 106 can identify pre-selected characteristics of a user. Such pre-selected characteristics include at least one of movement and position of the head 14. Preferably, the sensing means 106 is mounted within the housing 92. Such sensing means 106 may be a well known accelerometer/tiltmeter preferably sensing movement of the head 14 in all three axes.

The present invention also provides a control means 200 having a first portion 202 thereof disposed within the control device 90. The control means 200 also has a second portion 204 thereof that may be mounted within or attached to the machine to be controlled, simply positioned in a remote location, such as computer 28, integrated into a mobile communication device for example, such as a phone or Personal Digital Assistant (PDA) 24 which is continuously carried by a large percentage of the general public. The second portion 204 is in continuous communication with the first portion 202.

According to one embodiment of the present invention, the device 90 and the control means 200 enable the user to control a predetermined machine or perform a predetermined function. For example, the user is enabled to transmit at least one of image, sound and light onto a predetermined surface. Accordingly, such device 90 employs a transmitter 102. When the user is to transmit at least one image, the transmitter 102 will be a projector, preferably of a mini-projection technology projector type, mounted on the ear 12. By way of an example only, such projector may be a matchbox-sized laser-based monochrome projector manufactured by Light Blue Optics of Cambridge, United Kingdom or a PicoP projector manufactured by Microvision, Inc of Redmont, Wash.

The user can use this projector to watch TV, view what is on a computer screen, play a video on a surface on front of them, on the ceiling or on the floor as needed. The user can also transmit the image onto a hand if the user is away from any appropriate surfaces.

Such image can be a grid, ruler or a drawing that the projector will be capable of projecting, based on the distance, to the surface, for example such as a wall. The device 90 can employ the sensing means 106, for compensating the transmitted image based on the position and/or movement of the head 14 and, more particularly tilt, orientation, speed and direction thereof, as well as means, such as an ultrasound or infrared distance measuring device 108 for distance compensation. It will be appreciated that the outputs from the sensing means 106 and ultrasound or infrared distance measuring device 108 are received and analyzed by the control means 200 which then outputs a signal to the projector to display optimum image.

The image can be also a virtual keyboard with the projector being manufactured, for example, by iTech of Hunghom, Kowloon Hong Kong. The projector can detect “typing” movements, which interrupt the light beams, and interpret them as keystrokes with a very high degree of accuracy. The movements are then inputted as signals into the interface means 200. It is also within the scope of the present invention to employ teachings of the U.S. Pat. No. 6,943,665 to use tags 110 on nails as location transmitters, the location of the tags 110 indicating which character the user is typing. Existing gesture recognition software can be used to discern complex gestures.

It is also within the scope of the invention to provide a camera 103 having radio frequency (RF) transmitting capabilities. Thus, the image can be a picture of an object pointed to by the head 14 and/or by the outstretched wearer's finger(s) or in a scene and have machine vision or a human to assist to recognize and report the objects identity, and the objects salient characteristics through speech synthesis. This can be used to allow a person in a foreign country to point to characters on a door or menu and get a translation communicated verbally into the ear 12. Optical Character Recognition software interpreting the camera input to where the transmitter 102 is pointing can be also provided.

The transmitter 102 can be of a GPS type capable of transmitting location of the user or of a type enabling the Emergency personnel to transmit a signal to change red lights as they approach. It can also transmit certain values to a receiver based on user input or status, such as analog or continuously changing values, ex. dimming lights, or quickly changing values, ex. turn on/off/jog motor.

The transmitter 102 of RF type can be employed for issuing an elevator request or elevator floor request. This can be achieved without touching physical buttons with the second portion 204 of the control means 200 being mounted within the elevator control panel and having means for authenticating the user disposed therein. The means for authenticating the user may be of a type disclosed in U.S. Pat. No. 6,943,665. The device 90 can be linked to an invisible-communication security device using an RF transmitter 102, which advantageously can be disposed integral within a conventional headset 300 operating a wireless communication protocol such as Bluetooth. The signal from the device 90 will be received at the receiver 212 coupled to the second portion 204.

The device 90 can allow instant group voting using any of the IR, RF or laser transmitting means, similarly issue a map request to display a region of map on a public display, issue a subway stop request, start a car from a distance & request to turn on the A/C or heater. It can be also used as a training tool. For example, a child wearing the device 90 also incorporating voice transmission means asks “what's that” while looking at a picture in museum or monument. The nearly mounted second portion 204 of the control means 200 knowing the time, date, location, and direction looked at and having a connection to a database then causes voice synthesizer/recorded voice for the object's data in a database to provide the answer.

The present invention can be employed for various timestamp applications. For example, a device 90 may record in its data storage memory 112 the time and codes read from a local fixed RFID (or barcode) permanently fastened on a wall to ‘Time/Space-stamp’ an ‘I was there-then’ condition in the RFID reader/validator receiver/barcode reader or ODT reader that the wearer was there, as in a ‘guard-scheduled-checkpoint-post’ application. Other timestamp logging methods and uses include using its video camera to constantly record a scene and the start and stop time and date it was taken. Using rolling and/or normal encryption codes, GPS, and/or local position sensing means, along with its camera and data storage memory (such as an interface-able 8 GB micro-SD card), it can prove with a high degree of certainty the person was there at that time, viewing the scene and/or speaking those words simultaneously. The timestamp can be used for sole determination of when to start and stop a movie scene. Alternately, in a meeting, at a sporting event, or at a movie set, data recorded by a separate video camera, with timestamps embedded in it, is later downloaded and compared (for example by way of a computer) with the default timestamps and predetermined scenes matched by the timestamps, may be extracted for additional use.

Thus, time stamped data could be a continuously recorded voice and/or video recorder whose data can be later matched up by a particular timestamp and only the desired scenes would be extracted. This could be done at a distance and/or silently without a separate operator or a ‘remote control’.

An optional switch or set of contacts 114 may be provided within the device 90 for enabling the user to signal operation mode/state change requests to the second portion 204 of the control means 200. For example, the switch 114 may be used to switch between secure and non-secure operation of the control device 90.

It is within the scope of the present invention to use a plurality of transmitters 102 and a plurality of compensating means 106 within a signal control device 90. For example, to control operation of VCR 310, the user moves the head 14 in the direction of the VCR 310 and issues voice command such as “record NOVA next week” into a microphone 122 mounted within the control device 90. The acoustical signal is transformed into ASCII text within the controller 202 processed by the speech recognition means 126 and is transmitted in a digital form to the second portion 204 of the control means 200. The second portion 204 of the control means 200 mounted within the VCR machine 310 receives the head nod signal from the accelerometer, the head pointing compass direction from the magnetometer, the location from RF signal strength location sensing means or other local location sensing means. The control means 200 determines based on the received signals the command is meant for the VCR 310 and the text can be processed in several ways. In one aspect, the text is sent to the user's computer 34, which has an artificial intelligence (AI) engine running on it. The computer 34 already has the user's VCR make and model number stored in it and has also stored the appropriate signals to activate specific functions on the VCR. The computer 34 looks up, by way of online connection, (ex. via XML tag on a PBS website, or a TV schedule server) the date, time, duration and channel that the TV program NOVA is going to be on. The computer 34 encodes the remote control signals needed to perform that action on the owner's make and model VCR 310 and transmits the code to a receiver 116 of the device 90 and then through the device 90 to the VCR 310 the user is standing in front of and head 14 aiming towards.

In another aspect, the user can subscribe to a remote service 330 which transmits their currently selected TV channel numbers stored within a memory 112 of the device 90 or sensed by a sensor 120, for example such as IR remote control sensor. The remote service 330 which knows user's accumulated general TV likes/dislikes can automatically and statistically advise the subscribers of similar tastes that this program is a better fit to their tastes or prevent the user from missing anything better on TV and enabling the user to optimize viewing by receiving the statistical advice and/or remote control signal. Thus, the device 90 can be allowed to automatically transmit a signal to change the channel to something the user is more likely to enjoy based on the category of people the user belongs to. This is especially valuable to the severely disabled who may prefer means for learning their preferences and gradually eliminating the need for active control by the disabled user.

It is also contemplated to employ the remote service 330 for a more sophisticated voice recognition power and/or human interpreters to discern word content and command meaning complex tasks associated with transmittal of the analog voice from the device 90 as well as for desired actions associated with such voice commands. By way of the examples only, the user will be able to book airline tickets, find necessary information or location or relay a message.

It is also within the scope of the present invention to employ voice commands to communicate with and through the portable mobile communication device 24 such as a phone or Personal Digital Assistant (PDA).

The transmitter 102 may be of a type capable of transmitting laser or non-laser light or IR in the form of a divergent beam, rather than a collimated beam (for communication or power transmission). The characteristics of the light/IR can involve a variable illumination density profile light source/lens/filter with light/IR brightest in the middle. The transmitter 102 can also generate a circle of light where the middle is the darkest region. Alternately, at times the transmitter 102 may also use millimeter wave RF and/or ultrasound beam.

The transmitter 102 may be of a type capable of transmitting sound such as data or text. Thus, the device 90 can function as a voice transmitter and as an enhancement to voice-recognition software/hardware. The voice transmission can be also augmented by a head position compensating means 106. For example in a noisy environment, the word sound ‘no’ may be coupled with the wearer shaking their head side-to-side (sensed via angular-rate gyroscope chip and transmitted signal sent simultaneously with sound signal) to better discern the word “no” is intended.

When device 90 is capable of transmitting sound, the control means 200 will contain above described speech recognition means.

The transmitter 102 can transmit simple raw audio that will be received by the control means 200 having voice recognition means 210 disposed therein.

The control signal transmitted by the device 90 can be sent without the identification data for simple operations such as turning on lights or appliances in a building so that the user of the device 90 can be assured he/she cannot be tracked and will not compromise privacy.

The control signal can be transmitted in an ascending signal strength control signal output with handshaking mode. This signal sends a command at a ramping up signal strength. At 0.1 milli-watts, then 0.2 mW, then 0.3 mW until the signal strength is of sufficient power to ‘reach/activate’ the external machine to be controlled. There will be a temporary maximum emission Wattage level, in which case if the machine was too far away to signal, the interface means 100 would prompt the user indicating that maximum Wattage had been reached and no response form the machine has been achieved. The user could then give permission to continue increasing the signal strength or move closer to the machine and try again using the new maximum power setting. When that external machine is finally reached, it acknowledges reception of the signal, preventing a further increasing/escalating of the signal and preventing activation of another machine that may now be in communication range. For example, a TV, which is directly aimed at and ‘told’ “67” will go to channel 67 but a thermostat in the same room but further away or not in the direction the head was pointed, most likely will not receive the same signal at the same signal strength simultaneously and go to 67 degrees. This allows selection only of the one desired machine, which is closest to being pointed at, to be activated. Alternatively the voice command “CHANNEL 67” will be received by both the TV and the thermostat but only the TV will respond whereas only the thermostat will respond to “HEAT 67”, “COOL 67” or “Temp 67” or “67 DEGREES”.

The signal strength can be also varied depending on whether the user is in indoor or outdoor environment.

The control signal of a laser type may be transmitted in a variable focus or beam angle, ranging from very narrow to wide. The beam may be also directed roughly straight ahead, but be diverging. The device 90 can contain a blue laser transmitter allowing the user to move their head 14 and draw on a luminescent screen in a meeting. Selectable angle lasers are also contemplated within the present invention.

The transmitter 102 can be mounted behind the ear 12 and pointing in any direction suitable for controlling a machine.

A transmitter 102 capable of generating steerable millimeter wave focused RF beam can be used to enhance or replace the transmitter 102 generating visible or IR laser pointer. This would allow the device 90 to be hidden completely under hair or a hat to function properly, or allow the beams focus angle and/or direction to be easily adjusted, or to be scanned.

It would be appreciated that the laser beam may be employed to detect bar code labels by scanning the bar code and using the devices optional light sensor or using a CMOS camera image sensor to recognize the bar code.

A head mounted video display 128 may be employed to receive signals from remote locations and display data such as bar-code translations into items. Reading of bar codes and the connections to the internet could provide information about a product, which cannot be obtained by observing the product alone.

It is also contemplated for the device 90 to contain a modulated retroflector 130 for a low power transmission.

The receiver 116 can be provided in different types depending on intended application of the control device 90. It can be of a type capable of receiving light and function as a lighting flash sensor. It can also function as a modulated light signal receiver ‘telescope’, optionally with an iris or zoom lens to focus on and select out a distant signal and/or a small signal adjacent larger ones to where the head 14 is pointed. The signal may be modulated in digital ASCII form or raw audio and played back through the speaker 132. A blind user can determine the direction of a light source by moving his finger until it blocks the light signal to the sensor, and the sound generated by the light signal in the headset is no longer heard or is changed in frequency or volume. This indicates the direction of the light.

The receiver 116 may be of a sound receiving type. Thus, the user can move the head 14 and through the head position compensating means 106 answer cell phone in ear 12.

Voice commands can be received by a microphone 122 disposed within the ear canal. Such microphone 122 may be of a well known MEMS microphone manufactured by Akustica, Inc of Pittsburgh, Pa. The commands can be processed within the device 90 and transmitted to the interface means for further interpretation and handling.

Capacitance sensors extending to the facial areas can be used to generate additional commands from disabled users. Such plates placed in front of cheeks will detect cheek movement to supplement or replace other inputs.

In some modes of operation, when interface means detects absence of other inputs indicating that attention is not needed, the voice or sounds may be ignored, eliminating environmental sound noise.

Sounds received through the microphone 122 and transmitted to the second portion 204 of the control means 200 may be recorded by the recorder 210 disposed therein or sent to the mobile communication device 24.

The receiver 116 may be also of a type capable of receiving data. For example, the device 90 can contain or interface to a GPS sensing means, local positioning system (LPS), distance sensor, direction sensor, motion sensor and/or other ‘location aware’ technologies. The GPS (with its location and derived speed data) can be interfaced to a street database with speed limits in it and using the speaker 132, notify the user by way of voice when the user is entering a new area/street with a different speed limit, or to discreetly warn the driver periodically how much he is over the speed limit. This is especially useful for older drivers.

The receiver 116 may be of an infrared thermometer/pyrometer useful for the disabled to determine the temperature of their food.

The present invention also contemplates the use of an optical data transponder reader (ODT) 134 preferably disposed within the device 90 to perform a query function. The purpose of such ODT reader 134 is to query, in a remote manner from a distance, an ODT tag 344 which is mounted on an object that is within the scope of user's interest and obtain predetermined information contained within such ODT tag 334. The user can then transmit a control signal according to the embodiments described above in order to perform a specific function or to control a machine.

By way of examples, the ODT reader 134 allows the user to query a refrigerator/freezer for its contents or query a general kitchen database, either locally by directly accessing refrigerator data server ODT tag 344 (generally done when user points to an appliance data server tag located on the appliance, and dwells there or states “read”) or remotely through a mobile communication device 340 knowing where the user is in the house (using local location position reporting system or ‘local positioning system’) and the orientation of the head 14, and the appliance known to be placed previously in the location in the house and issuing a verbal information request to that appliance's database via voice recognition by LAN/WAN link. Using this means, the user can query the age of various items in the refrigerator/freezer. The user can similarly keep track of the grocery list. The user can similarly relay notes left for other family members or general reminders. The user can access/read/write information of how to prepare of serve items in it. The user can access warning information about allergies or what foods should not served to people with certain conditions. The ODT tag 344 can also be on specific food containers and not just on the refrigerator itself. These ODT tags 344 can detail nutritional content or cooking time and date. The user can scan it with the control device 90, which then transmits the data to a computer 34 to see how much he/she is ‘allowed’ to eat before exceeding his daily intake of sodium/cholesterol/calories/etc. This is useful for people who are dieting as well as people with dietary restrictions. The user can query a drawer for contents locally by accessing a drawer data server by pointing to the drawer data server ODT tag 344 mounted on the drawer and issuing a verbal information request to its database via voice recognition or remotely by a LAN/WAN link. Alternatively, the user can read a drawer ID by a bar code located on/in the drawer and by LAN/WAN link access the database data associated with that drawer.

It can allow the user to query an ODT tag 344 on a blender for model number, and then report to the manufacturers parts supply service that a new cutting blade is needed. For example while pointing to the blender's barcode or ODT tag 344, the user will simply speak into the microphone 122 “Manufacturer . . . need new blades”. The model number would then be transmitted to the manufacturer along with the text ‘need new blades’ and a cost would be emailed or part ordered if under warranty or etc.

An ODT tag 344 for an appliance enables the user to download and read the manual for the appliance, warranty data, serial number, model number, etc. It can also write the owners address information into it (OTP prom) if it goes into the shop (or as anti-theft and recovery information), repair history, maintenance history, attachments available, authorized sales price reduction due to damage, insurance info, etc.

An ODT tag 344 for a postage stamp enables the user to issue voice command regarding the destination and any special instructions or greetings.

An ODT tag 344 for a part enables the user to access the part's history or trouble log, part specs, proper care, etc. This can be accessed by machine or voice I/O. Complex group data interactions can be set up or served by the present invention. For example, a person A selects and reads a bar code, ODT, or RFID of a defective part using control device 90. Person B looks for the new replacement part using the data automatically sent to his mobile communication device 340 from the device 90 used by the person A.

An ODT tag 344 for a price tag could be used in an auction situation to receive and record highest bids and bidder ID on for the respective item or aid in shopping for such item.

An ODT tag 344 for an article of luggage enables the user, such as an airline luggage handler, wearing the device 90 coupled to the control means 200 to identify destination and other information of the article of luggage from the distance eliminating the time needed to locate such information in close proximity to the article of luggage and reduce overall time for handling such article of luggage.

For example, such sensor 120 may be a light level sensor capable of sensing a low light condition and the device then performing a function based on this, such as turning on house or room lights, particularly in combination with the LPS receiver. Directional control can be also employed to turn on lights in a specific area being pointed to. It will be understood that the present invention can be employed for performing tracking functions by pointing the device 90 to a specific area, using the head position compensating means 106 and transmitting a control signal in order to control a machine. The device 90 can point to an area on the lawn with the coordinates being stored in a database to be watered later by a robotic lawn watering system. Or, the device 90 can point and outline an area to be cut in a sheet of plywood or point to 2×4 wood stud location to be cut with the user issuing specific voice control command for example such as “cut 22 inches long” or “cut 26 inches by 14 inches rectangle”. The device 90 may also read the hand movements/writing movements from a data-logging computer pen and save the information to memory, wristwatch mounted accelerometer with transmitter, or ODT tag 344 on the user's nails.

Alternatively to or in addition to tracking movements of the head 14, the present invention provides for tracking movements of the user eye or eyes 15. In order to achieve this, a camera 140 is provided within the device 90 and is capable of generating a signal which is bounced off a mirrored area on the interior surface of the lens 374 of the pair of eyeglasses 370. The camera 140 is coupled to the control means 200 for receiving orientation control signal transmitted by the compass transmitter 102 within the control device 90, particularly in combination with the GPS means. The tracking camera 346 will then aim to where the user is looking at. Some of the uses for this embodiment includes controlling telescope at sporting event, move a cursor, monitoring eyelid position for medical purposes,

Tracking movements of the head 14 and/or eye 15 either by the tracking camera 346 or by the software logic performed within the second portion 204 of the control means 200 can be employed by the user in generating silent response by assigning a specific tracking value to each letter of the alphabet.

When the user wear eyeglasses 370 with switchable, electro-active optics that can rapidly change focusing power from distance to near vision such as electro-active lenses manufactured by PixelOptics of Roanoke, Va., the movement of the head 14 sensed through the head position sensing means 106 may be employed to switch eyeglasses 370 between near and far vision. The device 90 can also include power switch 136 coupled to the head position sensing means 106 in order to selectively supply or discontinue power to the eyeglasses 370 or any other device used by the user based on the movement magnitude and direction of the head 14 or lack thereof. The control means 200 provides a logic algorithm that discriminates between such magnitude and direction in order to output proper and unique feedback signal to the control device 90. For example, one unique feedback signal will be outputted when the head 14 tilts approximately 15 degrees forward while another unique feedback signal will be outputted when the head 14 tilts approximately 15 degrees to right side and yet another unique feedback signal will be outputted when the head 14 tilts approximately 20 degrees to the right. Furthermore, the distinction may also be made based on the speed of the movement. Accordingly, a three-direction accelerometer 106 is presently preferred for employment within the control device 90. Obviously, the control means 200 will be programmed to tolerance signal noise due to predetermined small magnitude, speed and direction movement increments as well as to compensate for loss of signal strength up to an acceptable level.

It will be appreciated that using movement of the head 14, by way of the head position sensing means 106, to generate a control signal transmitted by the transmitter 102 may be employed in a variety of machine control applications and query functions including but not limited to operating ipod, Internet query, appliance control, camera movement and the like. It will be understood that using movement of the head 14 provides for such machine control and query function in a hands-free manner enabling the user to use hands for other purposes.

Furthermore, the use of the microphone 122 and the speaker 132 can be provided in combination with an actuator which would provide tactile signaling for situations such as when the ambient noise is too high for reliable communication using the combination microphone and speaker alone. The tactile signaling could be a signal vibration or could be a pattern of vibrations.

The input output loop employing the device 90 and the control means 200 is illustrated by way of an example related to thermostat control and further in combination with the mobile communication device 340, such as PDA, containing the interface means 200. The user moves the head 14 and speaks “72” while looking at and pointing to his home furnace thermostat. The analog voice signal (“72”) which contains the sound the user pronounced while moving the head is sent via Bluetooth wireless protocol from the device 90 to the PDA 340. The PDA 340 receives the signal and performs voice recognition on it and determines that the user said “72”. The PDA 340 then converts the sound signal “72” to an ASCII signal ‘72’ and transmits it back to the device 90 again via Bluetooth protocol. The device 90 reads the Bluetooth signal and transmits the machine readable ASCII code ‘72’ to the thermostat pointed to by the user's laser/millimeter wave transmitter 102 and the thermostat receives the signal and sets the temperature set point to 72 degrees.

By way of another example, the input output loop employing the device 90 and the control means 200 is illustrated in combination with a vending machine 350 which receives the control and user ID signals from Bluetooth headset 300 positioned in front of it, vends requested items and bills the user for the transaction. The vending machine 350 can accept an individual's pre-deposited money into the machine, and keep track of the account, offer a discount if paid by this means. The vending machine 350 may also accept verbal password authentication from the microphone input of the headset 300, or issue verbal account balances thru the headset's speaker. In this manner the user does need not carry currency and spend time associated with use thereof.

Similarly, the Bluetooth headset-only embodiment can be used in a parking garage to allow exit, with less time consuming actions required. The user first deposits money (or gives credit card number) while standing in front of machine with the headset 300 on, and thus ‘opens account’ based on the unique id of the user or headset, the user then later goes to the garage exit with headset on and it senses who is exiting and debits their account/card automatically/more quickly allowing faster exit and optionally offering discount for that method. Simultaneously, a video camera time lapse recording can resolve any disputes later or if system/RF signal was spoofed. This can also be used as an EzPass system to pay for road tolls or to pay for gas.

A highly directional/high gain antenna is seen as a useful component in this system, selecting only/mainly/mostly the occupant in the selected vehicle's driver's seat, and rejecting others in the vicinity (depending on antenna gain, signal strength, location, etc). Other omni directional antennas can be used to compare with other local signals and reject other nearby users, isolating the desired wearer. The advantage of a Bluetooth-like headset 300 over the existing EzPass system is in that the headset 300 is more likely to stay with the user and less likely to be stolen or code stolen when the user is not present, the headset is easier to lend to another family member or business associate, the headset 300 can accept and relay voice instructions, emergency information, user-specific information (such as “exit 11 which you often use has been closed due to an accident”) or account balances, the headset 300 typically has a pushbutton allowing the wearer to transmit a request/response/acknowledgement, the headset 300 can be used to transmit a verbal acknowledgement, voice recognition input data, etc. or signal strength changes or signal polarization changes due to headset removal or head motion may be interpreted as commands, etc.

The present invention also contemplates that the second portion 204 of the control means 200 can be provided within a dedicated Data Server (DS) 380 tasked with controlling and monitoring various machines within a predetermined domain for example such as personal dwelling, manufacturing floor, office building and the like. Such DS 380 can be stationary disposed as a stand alone device or may be physically located within the computer 34 employed by the user.

Of a particular advantage is use of the device 90 in combination with the headset 300 particularly operating on a Bluetooth communication protocol as such headset 300 has gained wide acceptance for a hands-free mobile communication and is already worn by the user. Accordingly, the present invention provides for both physical integration of the device 90 into the headset 300 as well as mechanical attachment of the device 90 to the existing headset 300. Thus, the device 90 will utilize the structure of the headset 300 in order to generate and transmit control signal as well as use the microphone and the speaker built thereinto. It will be appreciated that the use of the headset 300 reduces the complexity and cost of the device 90 while enabling the user to generate control signal by head movement and voice command.

Although the above described embodiment has been shown in terms of the device 90 worn by the user, it will be apparent to those skilled in the art, that the present invention may be applied to other applications. For example, the device 90 and the user interface control means 200 can be used to control stuffed toys, robot toys, RC toys and the like. Similarly, the device can be used to control a UGV or UAV using voice, head tilt or other means.

The device 90 may be configured for use by pets particularly to allow the pet to interact with the owner or devices such as RC controlled mice pet toy.

According to another embodiment of the invention, the device 90 and the user interface control means 200 may be employed for monitoring, in unobtrusive, inexpensive, and continuous manner, health and vitality of a person as well as be employed by those who lost use of an organ or a limb. Since the device 90 is worn on or about ear 12 it is simple and effective to generate improved Quality of Life metrics for the elderly and disabled, to monitor fatigue or health status of firefighters, first responders or soldiers, generate emergency reporting for patients recently released, monitor location of individuals with Alzheimer decease, act as a physiological diary or transmitter, replace existing “pull-cord” applications or immediately alarm in the event of a detected fall condition, especially if the victim is rendered unconscious by using the accelerometer 106 detecting movement and position of the head 14.

As has been described above, the user wearing the device 90 for health reasons is able to control output signal by way of voice or head movement and receive discrete sound input.

A device 90 may be dispose din the ear canal for the purposes of temperature measurement, swallowing information, and/or body-based gasses analysis. An access is also easily obtained to a region of flesh that has been traditionally pierced/penetrated for cosmetic purposes, but can be pierced for medical blood sampling purposes or to a thin region of flesh surrounded by empty space, useful for optical medical monitoring and security purposes by placing a sensor-transmitter pair on each side. Due to the thinness and area ratio of the biological membrane, a large blackened area surrounding the sensor-transmitter pair allows for a great reduction in noise from ambient light penetrating thru the flesh to the sensor. Additional advantages of mounting the device 90 on or adjacent the ear 12 provides a region which does not come near or into contact with safety hazards such as moving machinery, unlike the hand/wrist region, a region which has access to vestigial movement of the Auricular muscles, unused for any other purposes, a region near the jawbone an molar teeth, a region on which objects are generally worn, including glasses, earrings, hearing aids and more recently wireless Bluetooth headsets 300 or wired headphones/earphones, a region in close proximity to the human brain, matching the physical movements and physical shocks accelerations and/or decelerations of the brain, a region which automatically points toward/has access to both the area the user is facing, the area behind the user and the area to one side of the user, only the top of the head 14 has more accessibility span in a practical sense, a region which has access to extremities, yet remains relatively motionless while walking, compared to the arms, or legs and/or a region on which a large device and battery can be comfortably, unobtrusively worn or hidden, especially behind the ear or near the hair.

In addition to reporting head orientation (lying or sitting/standing), head movement activity, relative location or change in location, this device 90 worn on the ear could also accept, through its input interface module 138 in either wired or wireless manner, inputs from other independent devices (not shown) or sensors (not shown) worn by the user for the above described health related or other functions. For example, blood oxygen levels, body temperature, and blood glucose levels can be effectively monitored by the present invention. Some blood glucose monitor methods, using the unique physical properties of the ear region can perform measurements there more conveniently or better than other regions of the body. For example, the monitor shines a light through the thin ear membrane, uniquely accessible on the body, or uses out-gassing to sense glucose or other blood component levels. U.S. Pat. No. 6,949,070 to Ishler discloses such monitor solely based on temperature measurements taken from the ear 14.

A region of very accessible thin body/ear membrane with very low ambient light penetration can be created with a blackened flexible magnet on each side of the ear membrane with the sensor detector pair in the middle, giving more favorable signal/noise light characteristics.

Of a particular importance is a capacitance-to-ear measurement which, by a magnitude of change, may signal that the device 90 has fallen off or has been removed.

The use of the accelerometer 106 is advantageous for monitoring vitality of a soldier fighting in the battle or a firefighter fighting fires. A significant rate of change of the output in a vertical direction would indicate that such individual fell to the ground and lack of subsequent change in output signals all three directions would most likely indicate that such individual is physically hurt, unconscious, and/or is unable to move and trigger an alarm condition by generating and transmitting an alarm signal from the control device 90. It is also advantageous, that such individuals are likely to wear a headset 300 for communication purposes. Since such individuals also wear helmets 360, the device 90 can be integrated into such helmet 360 and further in abutting engagement with the skin portion. Prior to the present invention, specialized military monitors are usually worn on the torso and generally measure cardiovascular electrical signals and do not enable measuring other factors such as body temperature, talking, eating, or swallowing. Furthermore, current approaches would be less sensitive in measuring fall events and certainly less sensitive in recording abrupt head deceleration due to contact with the ground or floor surface. In these applications, the device 90 may be adapted to interface with or directly employ sensors used for determining presence of smoke, chemical agents, radiation, biological agents, and toxic elements, warning the user of such presence and further transmitting a predetermined alarm signal associated with such condition, for example by way of an RF transmitter 102. The alarm signal can then be used for a verity of emergency medical response applications. In certain predetermined conditions the alarm signal can be used to enable an injection type device, such as Epi-Pen, Asthma inhaler and the like and administer medication to the ear or an adjacent head region, near where the readings have been taken.

The health monitoring functions can be combined with the security functions, which will be described below, to enable the device to be ‘Situation Aware’ and/or ‘User Aware’. For example, a Secured wearer's security level or access to a restricted area may change if the environmental detecting sensors on (or associated with) the device 90 sense radiation/smoke/chemical/biological contamination and/or the physiological (ex. pulse rate, body temp, blood oxygen, alcohol concentration etc.) detecting sensors sense a deterioration or change in the user's health status. For example, the user may be allowed into a secured area and, if there is radiation detected, allow him to escape the contaminated area. Alternately, the user may not be allowed into a secured area if his health status indicates he has a fever and the potential of spreading disease to others there exists.

An integrated sensor 120 capable of sensing alcohol or other compounds such as described in U.S. Pat. No. 5,345,213 to Semancik can be used to detect the vapor concentration in the ear canal or other regions nearby the ear. If vapor concentration levels are found to exceed a predetermined threshold, the user may be prevented from driving, operating machinery, or other similar functions. Combined with the security function of identifying the user, it can prevent a user from undetectably removing it or placing it on an accomplice.

The device 90 may sense and transmit an alarm signal associated with inner ear temperature by an in-ear radiation pyrometer 142 such as the type manufactured by Perkin Elmer under model TPS333 or sensor 120 capable of external non-contact temperature measurement. Such sensor may be infrared thermometer MLX 90614. This can indicate the presence of a fever or if the user in suffering from hyperthermia or hypothermia, as well as less severe cases of being too hot or too cold.

If the user is sensed to have a high temperature, the user may be allowed emergency access to a device, such as a medicine cabinet (it unlocks if he is near or in front of based on signal strength) containing appropriate medication. If the user has a temperature, he can get medication from a specially modified vending machine 350 containing codeine or pseudo ephedrine in accordance with the above described methods. If the user is sensed as having a low blood sugar the user may get fast, “free” access to candy/soda from a vending machine 350 equipped with a suitable ecommerce transaction RF receiver, such as the existing vending machines which enable purchase via cell phone. The vending machine record's the user's code and bills him later.

Using the sensor 120 of a magnetic type or sensing the signal from a magnet 150 embedded in a molar as the jaw moves, actions such as eating, coughing, sneezing, talking, etc. can be better examined, logged or monitored.

It is within the scope of the present invention to measure the strength of the RF signal by a RF receiver 210 and perform functions based on the measured signal strength. This can be used, for example, in order to determine if the user is present in the driving seat of the vehicle or at the operator location near a machine.

A simple driving drowsiness detection can be achieved by issuing sporadic random tones to the ear speaker 132 and requiring the user to respond with a specific word or head motion at that time. The response delay may indicate the level of the user's reflex time and degree of sleepiness. A prolonged delay results in a much louder tone to wake the user up.

The above described ODT reader 134 may be adapted for reading ODT tag 344 containing medical information in order to receive proper instructions and warnings, log events, gain access to medications, query the status of containers form a distance, query the medication quantities, locating or notifying a patient if they need to do a test, notifying the patient of presence of visitors phone calls events and the like and perform other medical related functions.

It is within the scope of the present invention to monitor the exercise activity of the user by recording the data measured by the accelerometer 106 which is associated with duration of time that the user performs each of the standing, lying down, running, leaning on something, talking, eating, swallowing, and the like motions.

The present invention can be used for providing the security associated with storage and dispensing of controlled substances. It can monitor the activities associated with drug administration and verification and can log this information. It can enforce HIPPA security. It can monitor and restrict or permit access and entry to buildings, rooms, elevators, cabinets, files, etc. based on the health status or environmental contamination history of the wearer. It can also provide general Health Database computer security and authentication.

A doctor or other health care provider can securely perform tasks in a hands free way to create a more sterile and safe environment for the patient. An example would be adjusting medical equipment set points by using movement of the head 14 either in a stand alone manner or in combination with issuing voice commands into the microphone 122, authorizing the commands using security sensing capabilities, and transmitting the processed voice recognized text or unprocessed voice data by way of the transmitter 102. Equipment may be selected by laser link pointing to receiver 212 mounted on the medical equipment, transmitting the direction that the head 14 is pointing to which is sensed by either magnetometer mounted on the head or proximity to equipment based on RF signal strength.

The accelerometer 106 may be also used to sense when a voice command is about to start or is in progress. By sensing a head nod, and the location and direction the head 14 is pointing, the receiving software within the control means 200 can correctly interpret the intended action.

Other uses of the present invention in health related art can be evident in combination with the following examples. Cross-contamination or spreading of the infectious diseases can be minimized or prevented by providing hands-free contact-free control enabled by transmittal of the control signal from the device 90 due to movement of the head 14 or due to a voice command. RF signal and distance tracking means may be employed to measure vital parameters of the patient wearing the device 90 being interfaced to particular measurement sensors. The patients with different types of diseases are prevented from contact with each other based on unique ID signals combined with specific disease ID signals. Motion sickness can be reduced by using the above described mini-projection technology projector 102 mounted on the ear such as the Light Blue Optics matchbox-sized laser-based monochrome projector or Microvision PicoP projector and shining an artificially created artificial horizon based on the inputs from accelerometer 106 on a surface viewed by the user. Patients can be alarmed, by using sensors 120 capable of remotely measuring temperature, if the temperature of the food to be consumed that the head 14 is pointing to is above acceptable limits thus preventing undesirable burns particularly in severely disabled patients requiring robotic assistance. The medical practitioner can entry or log prescriptions or diagnosis by pointing the head 14 to a specific location containing receiver 212 attached to a recording or voice transfer machine.

The device 90 and control means 200 have been found advantageous for use by blind, death or mute individuals.

For example, the blind user can identify the desired direction, object location or instruction by simply moving the head 14 in a side to side motion and receive a voice feedback through a speaker 132 when the transmitted signal is received by a receiver 212 and processed by the control means 200 which then outputs a voice feedback signal. Employment of the ultrasound or IR sensor 108 for distance measurement will also enable the blind person to receive voice feedback associated with the distance to be covered. Use of ODT reader 134 and ODT tags 344 coupled with directional control and voice feedback provided by the device 90 enables the blind person to improve quality of life and self care. Use of RF or laser signal from the transmitter 102 may enable the blind person to alter traffic pattern by way of a traffic signaling device equipped with receiver 212 and control means 200 capable of receiving and processing such RF or laser signal also carrying the user identification. Employment of the camera 140 with subsequent optical character recognition and further with a voice translation enables the blind person to identify text instructions. Employment of sensors 120 of a light/luminosity type enables the blind person to identify colors by pointing the head 14 in a desired location or warn the blind person of an approaching electrical storm especially in a noisy environment.

A deaf or hard to hear person can receive tactile signaling or feedback into the ear 12. Commercially available vibrating motors such as those used in pagers can be used to generate the vibration. An example would be a deaf person being alerted to a smoke alarm condition sensed internally or externally to the device 90 and alerting the user by way of vibration.

The device 90 could also assist the deaf by vibrating upon hearing a sound. The frequency and intensity of the vibration would correspond to the frequency and intensity of the sound. This can be done by known frequency shifting techniques using the microphone as input and vibration generating device as output.

The microphone 122 in the device 90 can acquire sounds in the ambient environment and pass this to the processor which can perform an FFT and pattern recognition to discern thunder or a siren and then vibrate in response or generate tactile feedback using an electrical current sent through the skin by electrodes 144 mounted on the surface of the device 90 and in contact with the skin of the user. The same microphone 122 can be used to detect and log tooth brushing sound events using FFT and pattern recognition technology.

The sensor 120 of the motion type attached to the device 90 may assist a blind person crossing the street. As the person stands still, the degree of motion external to the person such as an automobile can be sensed and can be translated to a sound. If no motion is sensed and no sound is generated, a further indication of ‘safe to cross the street’ is indicated. The same sensor can indicate if someone is walking in front of them.

A mute person can take advantage of the voice synthesis based on the location the head 14 is pointing to on the x-, y-, and z-axes (specific tilts) with specific head motions programmed to generate specific words.

The device 90 worn by the person who is both blind and deaf can use the sensor 120 to detect the lightning flash or thunder. A GPS device can be used to further send coordinates, tones, tactile feedback or voice commands to the device 90 to indicate where/which direction a person should move to or be moving in. This provides a ‘course correction’ functionality.

Several quadraplegics can simultaneously use their transmitters 102 of a laser pointer type mounted within the device 90 to point to a projected computer screen simultaneously. A remotely positioned camera 346 used for tracking purposes and focused on the screen discerns the laser pointer location, differentiate lasers by color, and image recognition enabling the user or users to draw the path on the screen or perform other typical software functions such as selecting icons, moving sliders, running programs, etc. Alternately, the camera 346 sending a video picture of a region of wall or whiteboard with designated marked regions may be sent to an albeit more expensive Video Motion Detector with contact closure outputs which can be used to control various devices based on the pointer shining on preselected regions of the wall.

An input from camera 346 transmitted to the device 90 and received at the receiver 116 capable of receiving such signal can be focused on a reflective area of the lens 372 aimed towards the pupil/iris. Using well known image recognition techniques, iris tracking can command movement of the laser pointer 146 mounted within the device 90 to the desired location if the user is unable to move their neck. Alternately, the above described transmitter of 102 of a projector type may project predetermined data or image onto an opaque area of the user's eyeglasses 370.

It will be also understood the device 90 can be easily adapted with a sensor 120 capable of monitoring and using brainwaves from the head region adjacent the ear 12 for medical purposes or for use as a biometric authentication means.

According to a further embodiment, the apparatus 80 of the present invention is advantageous for controlling robots and unmanned vehicles.

The user can securely point to an object via laser pointer 102, select that object by turning on or increasing the intensity of the laser, deintensify the laser, reintensify the laser to point to and indicate the where the object should be moved and, if he wants/needs to, designate the specific robot/vehicle to perform the action. For example a person points to a box, using the microphone 122 says “move this,” points with his head 14 to the destination location and says “to here.” The laser or RF transmitter 102 is turned on and modulated by the voice recognition text ASCII output and the location, pattern and commands are observed by servant robots and performed. The volume of the voice may be used to control the intensity of the laser. The user can also indicate special instructions concerning the task being performed or the object it is interacting with, such as the object should be flipped over before being placed down again, it should be done by the same or another robot, or that the package is fragile and should not be tipped. It is important to note that the above described method provides for indirect robot control.

Similarly, the user can securely draw a square on the ground with laser pointer 102 while saying “dig 1 foot deep” and the robots will simultaneously observe where and what region to dig in, as well as the voice command of how deep.

The apparatus 80 could be used to train securely a robot to create art or crafts according to certain specifications.

The following illustrates an example remotely commanding an unmanned air or ground vehicle or other robotic device to make a right turn. The user tilts his head 14 toward the right shoulder slightly. The accelerometer 106 detects tilt of the head 14 and generates at least one information signal containing information about tilt of the head 14. The second portion 204 of the control means 200 receives such at least one information signal and sends a predetermined signal to the controller of such device which triggers a right hand turn. The user then tilts the head 14 to the original position thus discontinuing the turn operation. Similar logic can be applied to directing left-turns, climbing, descending, backing-up, moving sideways, lifting items, taking pictures, and performing the others function of the unmanned vehicle or robotic device.

The apparatus 80 can also ensure secure control of the robot. It transmits control signals by head movement along with proper password with each code. Similarly, the apparatus 80 can also be used as a secure mechanism to control, move and interact with an avatar within a virtual environment.

It can also be used as a secure hands- and eyes-free interface that allows military healthcare providers to capture patient encounter data while in a combat environment.

A hand laser can be similarly used instead of, or to be a useful addition to, a laser mounted on or controlled by the apparatus 80 to perform similar functionality.

It would be appreciated that adding voice commands and/or simple laser on/off commands enhances control capabilities.

According to another embodiment of the invention, the device 90 and the user interface control means 200 may be employed as a security apparatus 80 for enabling a user to interface with a predetermined object.

The security apparatus 80 includes the sensing means 106 engageable, either directly or indirectly, with a predetermined portion of a human skin. In accordance with a presently preferred embodiment of the invention, such predetermined portion is at least one of a human ear 12 and a predetermined portion of skin adjacent such human ear. The sensing means can identify pre-selected characteristics of a user. Such pre-selected characteristics include at least one of movement and position of the head 14. Preferably, the sensing means 106 is mounted within the housing 92. There is also provided means for attaching the housing 92 to the ear 12 of the user. Such attachment means may be a simple curved hook 94 which is positioned between the ear 12 and the skin adjacent the year.

The device 90 is generally constructed according to principles disclosed in U.S. Pub. No. 2005/0238194 published Oct. 27, 2005 and entitled “Ear Associated Machine-Human Interface” and whose teachings are incorporated herein by reference thereto.

The present invention enables the user to interface with a predetermined object based on the authentication of the user by an interface control means 200 having a first portion 202 thereof disposed within the housing and adjacent the sensor 106 and having a second portion 204 thereof mounted within or attached to the object.

In accordance with the presently preferred embodiment of the invention, the authentication of the user is achieved with a specific head movement sensed by an accelerometer/tiltmeter sensor 106. Other forms of the authentication either as stand alone or in combination with the accelerometer/tiltmeter sensor 106 may include (1) a standard password transmitted to the ear-based security apparatus (typically maintained as an authenticated status thereafter), or (3) a password uttered by the wearer or tune hummed into the microphone 122 and recognized automatically by software/hardware provided within the control means 200 or another human.

Authentication can be also provided by (4) an RFID transmitter 102 worn on or in the ear 12 and read by the ear-based security apparatus 80 or held in the hand, (5) a skill such as proficiency level in a specific game played, observed, measured and verified by an external device agent or individual, or (6) challenge-response questions to the wearer.

Yet another form of authentication could be (7) sensor 120 of a biometric sensor in the ear-based security apparatus 80 which one-time, continuously, periodically, or sporadically authenticates the wearer such as a fingerprint, skin spectrum, blood vessel, voice characteristics, or ear shape sensing device (for example, done by capacitance plates near the regions of the ear that vary from individual to individual), (8) response characteristics of the ear canal to sound (for example, resonance based on mechanical properties/dimensions or acoustic emissions), (9) biometrics verified externally by a separate device or person and transmitted to the ear-based security apparatus or a resulting authentication code transmitted to the ear-based security apparatus such as facial, fingerprint, iris, ear shape image recognition, and/or (10) your past or current location in space at a specific time. The fingerprint(s) may be of the wearer or of a person(s) authorizing the wearer.

The authentication output may be also provided by an illumination matrix which is discloses in related U.S. Pat. Pub, 2005/0219842 published Oct. 6, 2005 and entitled “Illumination Matrix With A substantially Symmetrical Arrangement” and whose teachings are incorporated herein by reference thereto.

The accelerometer/tilmeter 106 may be also adapted to detect removal of the device 90 from at least one of the ear 12 and the predetermined portion of skin adjacent the ear 12 of the user. This detection can be continuous, rapid periodic and/or sporadic.

Pressure switches/transducers contacting the ear/head, for example, piezoelectric flexible strips 95, can be used as another indication that the ear-based security device 90 has been removed or tampered with. If the pressure changes beyond a certain limit, within a specified time, the indication is the ear-based security apparatus has been removed or tampered with.

A wire or fiber optic link 96 around or through the ear 12, as in a pierced ear, can be used as yet another indication that the ear-based device 90 has been removed or tampered with wherein disruption of the circuit is detected when the ear-based security apparatus is removed.

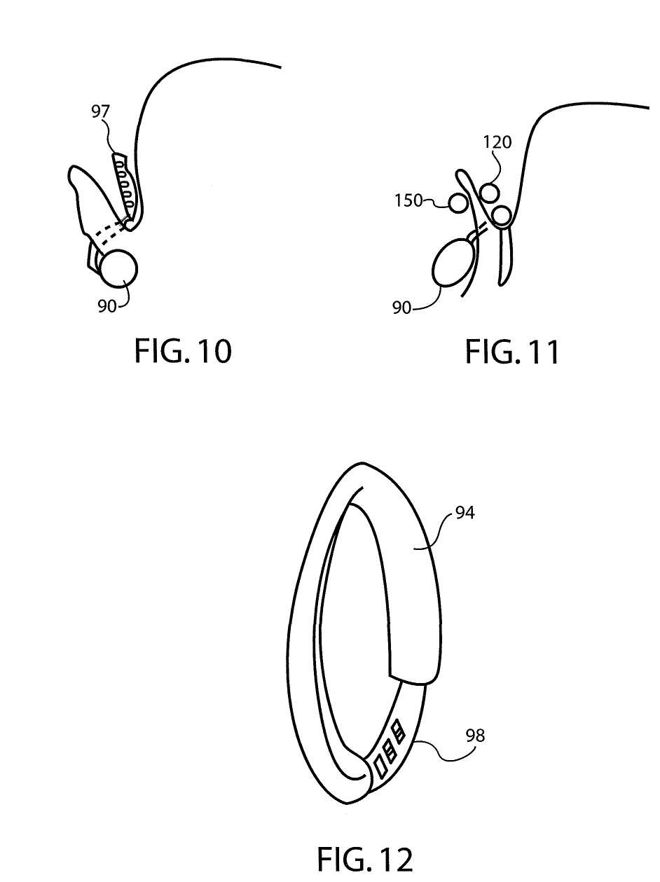

Capacitance detection of the conductive ear/head flesh near capacitance plates 97 in the worn ear-based device 90 can be used as an indication that the ear-based device 90 has been removed or tampered with. If the capacitance changes beyond a certain limit, within a specified time, the indication is the ear-based security apparatus has been removed or tampered with. The capacitance plates can be worn on the ear 12 or behind the year 12, as best shown in FIG. 10. Capacitance plates custom fitted to the user's own semi-unique ear shape profile are also envisioned as means of further securing the user, especially in a high security environment.

A mechanically secured assembly 98, shown in FIG. 12, clamped to the ear 12 that cannot be removed without detection or detectibly damaging the device 90 or the ear 12, such as an earring, may be another way of detecting that the ear-based security apparatus 80 has been removed or tampered with.

A sensor 120 (for example, hall effect, or magnetic proximity switch) coupled to a magnet 150 placed on the opposite side of the ear 12, as best shown in FIG. 11, may be yet another way of detecting that the ear-based security apparatus has been removed or tampered with.

A conductive circuit through the ear/head flesh to the ear-based security apparatus being disrupted could be still another indication that the ear-based security apparatus has been removed or tampered with.

Finally, detection of biological properties of nearby ear/head, such as EEG, EMG signals, pulse, temperature, etc., could be used as a means of determining whether or not the ear-based security apparatus has been removed or tampered with or if the user is in an unconscious state or unhealthy. An electrical switch, magnetic, or RFID sensor in the device can verify appropriate safety gear with embedded magnets or RFIDs are being worn by wearer. An example would be a hood, hearing protection headsets, or respirator with a magnet embedded and sensed by the device.

The security apparatus 80 has a transmitting means 102 connected to the sensing means 106 for sending at least one predetermined signal to a predetermined object at least one of periodically, sporadically and continuously. The predetermined signal may contain information gathered by the sensing means 106.

Once the ear-based security apparatus 80 is authenticated to the wearer/user, it can transmit verification/authentication information separately/asynchrononously/independently/on demand to the predetermined objects requiring identification such as computers, access control systems, vehicles, door locks, ecommerce systems, handheld devices, etc.

The security level can increase or decrease based on conditions/situations such as authentication to a new/different device in the immediate vicinity, user's location, security alert level, etc. This may cause additional security measures such as additional passwords, additional new biometric measurements taken and sent to the security apparatus or read by it, etc. Alternately, once successfully inside a secured area/mode the unit may go into a lower security state and be removed or worn in a pocket, acting as a previously authenticated token. A lower security state may also measure the location of the security apparatus or proximity (for example, using capacitance to human body) as a security input or A Lumidigm sensor incorporated to measure skin spectrum of ear flesh to similarly measure skin spectrum of other regions of the body where it has been moved, such as physically secured through a shirt button hole or clipped to a collar.

The device's location in space/distance relative to the security receiver can be measured using methods such as relative RF or IR signal strength and be used to change security modes. For example, if a person strays too far from their computer, the authentication condition may stop.

The ear-based device 90 may include a receiver 116 coupled to the first portion 202 of the control means 200 and used to receive security codes, user commands or prompts which must be responded to. For example, the receiver 116 may issue/get an audible message in a foreign language known to user which requires the user to type in a correct response on a laptop, or a prompt to nod head 14 in a specific manner measurable and transmitted by accelerometer 106 in the device 90, or a prompt to perform a simple or complex ‘ear wiggle’ (especially one characteristic of the user's (physiological or learned) ability to accurately perform such a control motion, such as a specific, complex and accurate ear-pull maneuver over a specified time, or a command that requires a specific voice response.

The ear-based security apparatus 80 can change security states or transmit specific secured requests or messages, such as an ecommerce authorization or request, based on any of the user's actions stated above. The device can change state if physiological duress is sensed by physiological sensors or a struggle situation is sensed based on head movements.

The ear-based security apparatus 80 can operate in various security modes with a variety of equipment using Bluetooth-like (for example, RF or IF or visible/LED/laser) communication protocols encrypted and identifying/authenticating individual(s) to many different devices and equipment with little or no additional user effort and in extreme environmental conditions.

It can simultaneously track a person's location (and at what time) to verify they don't egress into unauthorized areas (and optionally warn/alarm them when they are about to enter such areas (based on their ID and/or their category of security level), direct them where to go, or etc. while it is being worn. More than one device 90 (ex. issued temporarily by an authorizing agency) can be worn and active simultaneously. It can also verify/ warn when a user is nearing another person they are prohibited from nearing, and validate where the user is when they are talking, verifying they have or have not talked to another specific person(s) similarly identified and continually authenticated wearing a similar device. The device 90 can also record, by way of a microphone 122 and speech recognition means 126, all spoken communication or sound events which occurred in classified areas. It can also verify head position or movement in sensitive areas to verify no attempt was made to observe sensitive information adjacent the individual (ex. glance inside a doorway while walking). Using a light sensor, it can verify the individual did not enter an area while a security strobe was flashing. Using a full fingerprint sensor and prompting/requiring the user to place finger (or fingers-both hands) on sensor(s) 120 worn on ear(s) 12, it can verify the individual did not write any information down or touch anything while in a specific area or near a specific individual(s). It can verify the light level or light coloration in a specific area was kept too low to adequately observe classified details or read classified materials on whiteboards. The device 90 can verify another person was met or change state by having the other person's fingerprint read/recorded. The device 90 can verify the ID of the wearer speaking to assure he is authorized to issue commands, or is indeed the pilot of a specific airplane flight. The device can discern using an in ear microphone that voice commands are indeed coming from the user and not from spoken voices from nearby. The device can control LCD shutters on security eyeglasses or goggles worn to impair or limit visibility of a secured wearer in a higher security environment he is not authorized to observe.

Finally, the device verifiably worn on the ear 12 can provide noise through the speaker 132 when it senses the individual is in sensitive areas, to prevent overhearing classified verbal information or briefings nearby. Any deviations in expected behavior can be immediately transmitted by a transmitter 102. Any attempts to tamper with the device 90 can result in it self disabling.

While a presently preferred and various alternative embodiments of the present invention have been described in detail above it should be understood that various other embodiments of the invention can be envisioned by those persons skilled in the relevant art without departing from the spirit of the invention or the scope of the appended claims.

I claim:

1. An apparatus comprising:
(a) a head rotation sensor disposed in a predetermined position for detecting at least one of a head movement and a head position of a user and generating at least one information signal containing information about said head movement and said head position of such user;
(b) a control means having a first portion coupled to said sensor for receiving said at least one information signal and a second remotely disposed portion for processing said at least one information signal in accordance with a predetermined logic; and
(c) means coupled to said control means and operable thereby to generate at least one control signal in response to receipt of said at least one information signal.

2. The apparatus, according to claim 1, wherein said sensor is one of an accelerometer and a tilt sensor.

3. The apparatus, according to claim 1, wherein said accelerometer is a three-axis accelerometer generating three information signals each associated with a respective axis.

4. The apparatus, according to claim 1, wherein said control signal generating means is a transmitter.

5. The apparatus, according to claim 1, wherein said at least one control signal is for at least one of controlling a predetermined machine, performing a predetermined procedure, monitoring condition, obtaining access and performing a predetermined function.

6. The apparatus, according to claim 1, wherein said predetermined position is on or adjacent an ear of a user.

7. The apparatus, according to claim 1, wherein said apparatus includes a fastening means for attaching said head rotation sensor, said first portion of said control means and said control signal generating means to at least one of a human ear and a predetermined portion of skin adjacent such human ear of a user.

8. The apparatus, according to claim 1, wherein said apparatus includes a remotely disposed sensor coupled to said second portion of said control means for receiving said at least one control signal.

9. The apparatus, according to claim 1, wherein said apparatus includes a means for measuring distance from said device to a predetermined object.

10. The apparatus, according to claim 1, wherein said apparatus includes a memory means mounted within said device.

11. A communication headset comprising:
(a) an ear mount;
(b) a communication base unit connected to said ear mount;
(c) a head rotation sensor mounted within said base unit for detecting at least one of a head movement and a head position of a user and generating at least one information signal containing information about said head movement and said head position of such user;
(d) a control means having a first portion coupled to said sensor for receiving said at least one information signal and a second remotely disposed portion for processing said at least one information signal in accordance with a predetermined logic.

12. A pair of glasses comprising:
(a) a frame having two lens holders connected by a nose bridge and two support arms each having a first end thereof affixed to a respective lens holder and having a second end thereof configured for engagement with an ear of a user;
(b) a head rotation sensor secured to a first predetermined portion of said frame unit for detecting at least one of a head movement and a head position of a user and generating at least one information signal containing information about said head movement and said head position of such user; and
(c) a control means having a first portion coupled to said sensor for receiving said at least one information signal and a second remotely disposed portion for processing said at least one information signal in accordance with a predetermined logic.

13. An article of headwear comprising:
(a) a head portion configured to receive a head of a wearer;
(b) a head rotation sensor secured to a first predetermined portion of said head portion unit for detecting at least one of a head movement and a head position of a wearer and generating at least one information signal containing information about said head movement and said head position of such wearer; and
(c) a control means having a first portion coupled to said sensor for receiving said at least one information signal and a second remotely disposed portion for processing said at least one information signal in accordance with a predetermined logic.

14. A method of transmitting commands, said method comprising the steps of:
(a) sensing at least one of a head movement and a head position of a user; and
(b) turning on a device mounted on said user when said sensing occurs.

15. A method for controlling a robot or a robotic vehicle, said method comprising the steps of:
(a) pointing a head mounted laser in a predetermined direction; and
(b) issuing at least one voice command associated with movement of said robot or robotic vehicle.

16. A method of controlling an object, said method comprising the steps of:
(a) providing a headset capable of executing communication protocol;
(b) measuring, at the receiver mounted on said object, strength of a radio frequency signal emitted by said headset; and
(c) executing a procedure based on said signal strength.

17. A pre-programmed security apparatus for authenticating a user to a predetermined object, said security apparatus comprising
(a) a sensing means engageable with at least one of a human ear and a predetermined portion of skin adjacent such human ear for at least one of identifying pre-selected characteristics of a user and detecting removal of said sensing means from such at least one of such human ear and such predetermined portion of skin adjacent such human ear of such user; and
(b) a fastening means for attaching said sensing means to such at least one of such human ear and such predetermined portion of skin adjacent such human ear of such user.

18. A security apparatus for enabling a user to interface with a predetermined object, said security apparatus comprising:
(a) a sensing means engageable with at least one of a human ear and a predetermined portion of skin adjacent such human ear for at least one of identifying pre-selected characteristics of a user and detecting removal of said sensing means from such at least one of such human ear and such predetermined portion of skin adjacent such human ear of such user;
(b) a transmitting means connected to said sensing means for sending at least one predetermined signal to such predetermined object at least one of periodically, sporadically and continuously; and
(c) a fastening means for attaching said sensing means and said transmitting means to such at least one of such human ear and such predetermined portion of skin adjacent such human ear of such user.

19. A security apparatus, according to claim 18, wherein said at least one predetermined signal contains data gathered by said sensing means.
